(19) United States
(12) Patent Application Publication
(10) Pub. No.: US 2024/0170931 A1
(43) Pub. Date: May 23, 2024

(54) MODULE PULLING CONTAINER

(71) Applicant: viaPhoton, Inc., Aurora, IL (US)

(72) Inventors: Keith Samuel MARANTO, Frankfort, IL (US); Mark James SMHRA, Chicago, IL (US); Walter Mark HENDRIX, Dallas, TX (US); Nathan Eric BENTON, Dallas, TX (US); Jeffrey Earl Jones, SR., Stewartstown, PA (US); Christopher Brian HASLEY, Gibsonia, PA (US)

(73) Assignee: viaPhoton, Inc., Aurora, IL (US)

(21) Appl. No.: 18/512,001

(22) Filed: Nov. 16, 2023

Related U.S. Application Data
(60) Provisional application No. 63/426,702, filed on Nov. 18, 2022.
(60) Provisional application No. 63/596,560, filed on Nov. 6, 2023.

(51) Int. Cl. H02G 1/08

(52) U.S. Cl. CPC H02G 1/081

(57) ABSTRACT

An apparatus embodies module pulling container. The module pulling container includes a housing structured to enclose at least one module terminating a cable. The module pulling container includes a front eyelet of the housing and a tapered front end of the housing. The module pulling container further includes a back eyelet and one or more retention members structured to support the at least one module within the module pulling container.

### CROSS REFERENCE TO RELATED APPLICATIONS

This application claims the benefit of U.S. Provisional Application 63/426,702, filed Nov. 18, 2022, which is incorporated by reference herein. This application claims the benefit of U.S. Provisional Application 63/596,560, filed Nov. 6, 2023, which is incorporated by reference herein.

### BACKGROUND

Modules for communications include plastic housings that contain an array of fiber optic couplers, fiber optic connectors, ethernet jacks, ethernet couplers, fiber optic splices, etc. The modules may be installed into rack-mount panels. Cables may be pre-terminated to these modules prior to installation at a facility (e.g., a data center). The pre-terminated modules (with attached cables) are pulled throughout a facility from one location to another through tight spaces. The modules may be pulled through conduits, cable trays, pass-through devices, etc. A challenge is to pull the modules through the tight spaces of a facility.

### SUMMARY

In general, in one or more aspects, the disclosure relates to an apparatus that embodies a module pulling container. The module pulling container includes a housing structured to enclose at least one module terminating a cable. The module pulling container further includes a front eyelet of the housing and a tapered front end of the housing. The module pulling container further includes a back eyelet and one or more retention members structured to support the at least one module within the module pulling container.

In general, in one or more aspects, the disclosure relates to a system that includes a cable and module pulling container. The module pulling container includes a housing structured to enclose at least one module terminating a cable. The module pulling container further includes a front eyelet of the housing and a tapered front end of the housing. The module pulling container further includes a back eyelet and one or more retention members structured to support the at least one module within the module pulling container.

In general, in one or more aspects, the disclosure relates to a method that uses a module pulling container. The method includes terminating a cable with a module and enclosing the module within a module pulling container. The module pulling container includes a housing structured to enclose at least one module terminating a cable. The module pulling container further includes a front eyelet of the housing and a tapered front end of the housing. The module pulling container further includes a back eyelet and one or more retention members structured to support the at least one module within the module pulling container.

Other aspects of one or more embodiments of the disclosure will be apparent from the following description and the appended claims.

### BRIEF DESCRIPTION OF DRAWINGS

FIG. 1 shows a block diagram in accordance with one or more embodiments of the disclosure.

FIG. 2 shows a method in accordance with one or more embodiments of the disclosure.

FIG. 3, FIG. 4, FIG. 5, FIG. 6A, FIG. 6B, FIG. 7A, FIG. 7B, FIG. 7C, FIG. 8, FIG. 9, FIG. 10, FIG. 11, FIG. 12, FIG. 13, FIG. 14, FIG. 15, FIG. 16, and FIG. 17 show examples in accordance with one or more embodiments of the disclosure.

Similar elements in the various figures are denoted by similar names and reference numerals. The features, elements, methods, etc., described in one figure may extend to and be used by similarly named features, elements, methods, etc., in different figures.

### DETAILED DESCRIPTION

In general, one or more embodiments are directed to a module pulling container. The container encloses the modules and includes front and rear eyelets to interconnect multiple containers of modules. The containers are sized to have a cross sectional area similar to that of the modules enclosed within and to be tapered to prevent snagging or getting stuck on obstructions when being pulled through pathways to be installed at a facility.

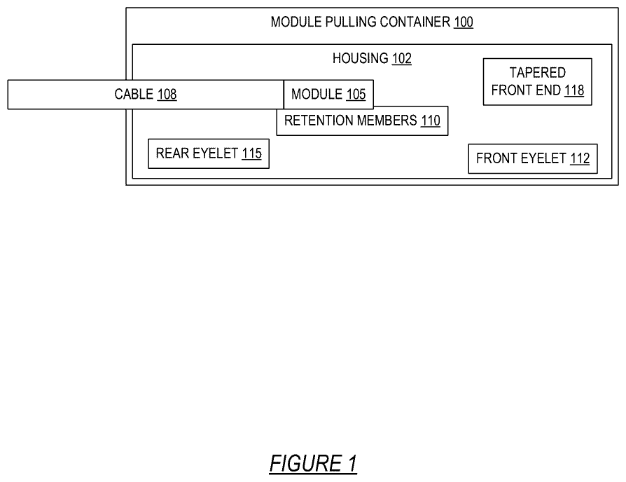

Turning to FIG. 1, the module pulling container (100) encloses the module (105) and a portion of the cable (108). In an embodiment, the module pulling container (100) may enclose multiple modules and multiple cables. The module pulling container (100) includes the housing (102).

The housing (102) encloses and protects the module (105) during installation of the module (105) at a facility. The housing includes the retention members (110), in front eyelet (112), and the rear eyelet (115). In an embodiment, the housing (102) includes one or more rounded edges. In an embodiment, an internal cross sectional area of the housing (102) is no more than ten percent greater than an external cross sectional area of the module (105).

The module (105) terminates the cable (108). The module (105) may include connectors, jacks, couplers, splices, etc., for wired and fiber optic networks. The module (105) may be structured to be fitted into a panel of a rack of a server.

The cable (108) is a communication cable. The cable (108) may include multiple cables, wires, fibers, etc. One end of the cable (108) is terminated by the module (105).

The retention members (110) retain the module (105) within the module pulling container (100). The retention members (110) may be integrally formed as part of the housing (102). The retention members (110) are structured to support the module within the module pulling container. The retention members may include a backplate, retention fins, retention walls, support walls, etc. In an embodiment, one of the retention members may be a backplate that includes the rear eyelet (115).

The front eyelet (112) is a component at a front end of the module pulling container (100). The front eyelet (112) is used to connect the module pulling container (100) to another module pulling container (not shown) in front of the module pulling container (100).

The rear eyelet (115) is a component at a rear end of the module pulling container (100). The rear eyelet (115) is used to connect the module pulling container (100) to another module pulling container (not shown) behind the module pulling container (100).

The tapered front end (118) is a portion of the front end of the module pulling container (100) that is tapered. The tapering reduces aids in pulling the module pulling container (100) through a facility by reducing the likelihood that the module pulling container (100) will snag or get caught in a conduit or pipe.

In an embodiment, the housing (102) includes an alignment tab. The alignment tab may be structured to fit into a slot of a backplate, which is structured to receive the alignment tab.

In an embodiment, the housing (102) includes a locking window formed as part of the housing (102). The housing (102) may further include a retaining clip formed as part of a backplate and structured to fit to the locking window. The locking window and the retaining clip operate in conjunction to secure the backplate to the housing (102) and retain the module (105) within the module pulling container (100).

In an embodiment, the housing includes a cable guide structured to provide cable bend radius protection. The cable bend radius protection limits the radius of the bend of cables (including the cable (108) routed through the module pulling container (100).

In an embodiment, the housing (102) includes an alignment guide pin of the housing. The housing (102) may further include an alignment guide hole of the housing (102) structured to receive the alignment guide pin to align portions of the housing together.

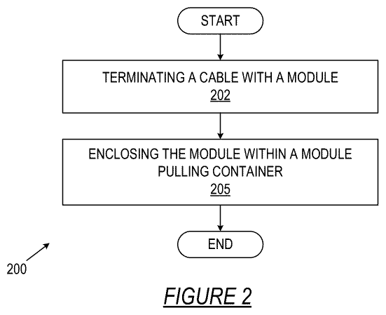

Turning to FIG. 2, the method (200) is used to install cabling in communication networks. The method (200) may be performed using the systems and components described in the other figures.

At Step 202, the method (200) includes terminating a cable with a module. Terminating the cable with the module may include exposing the wires, optical fibers, and smaller cables within the original cables as breakout cables. The breakout cables may then be connected to connectors and adaptors that are secured by the module. Additional insulation may be applied to the breakout cables and the module is closed to protect the cables, connectors, adaptors, etc.

At Step 205, the method (200) includes enclosing the module within a module pulling container. The module may be one of multiple modules enclosed within the module pulling container.

After enclosing the module within the module pulling container, the module pulling container may be pulled through a facility to install the cable at the facility. The module may then be removed from the module pulling container and installed into a panel that may be installed into a rack of a server.

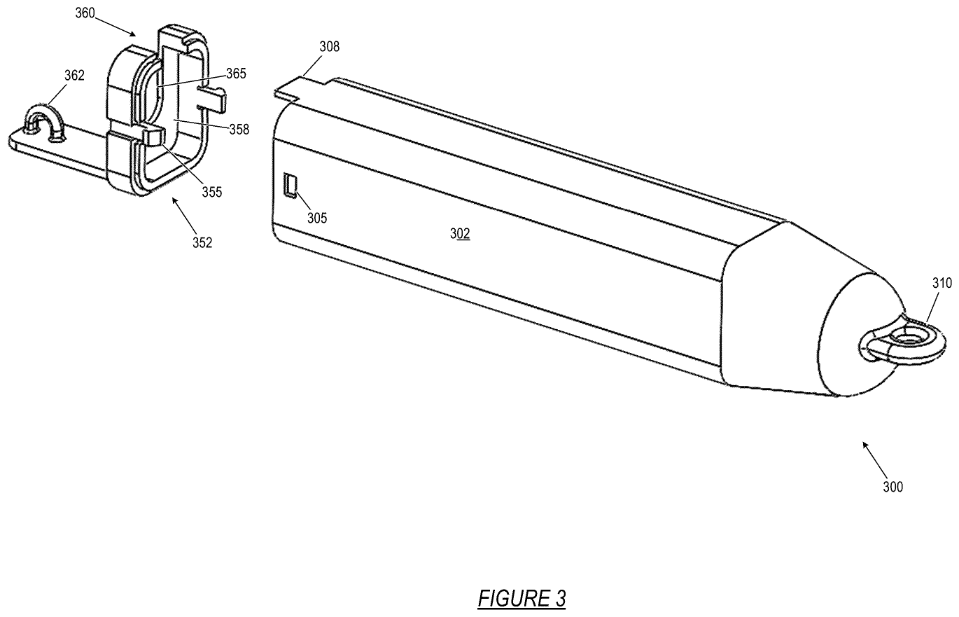

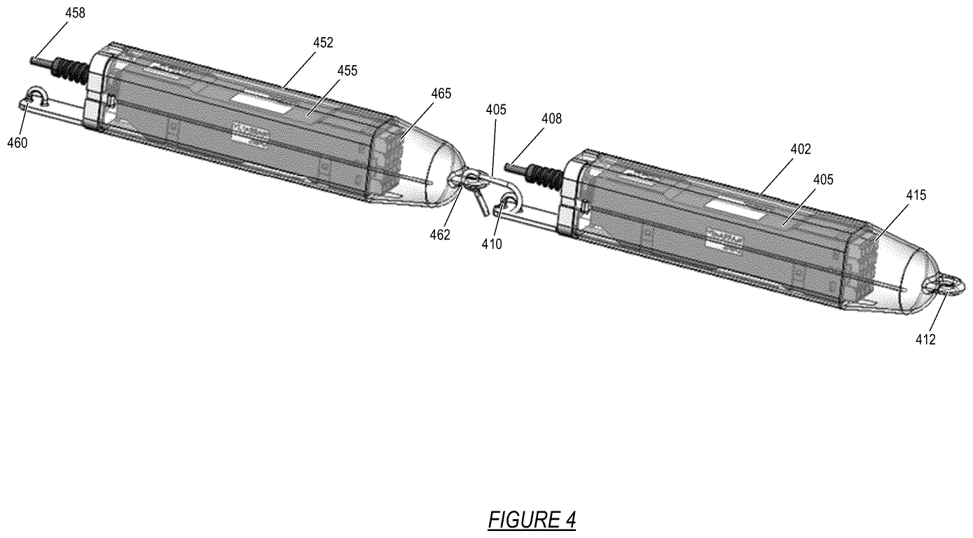

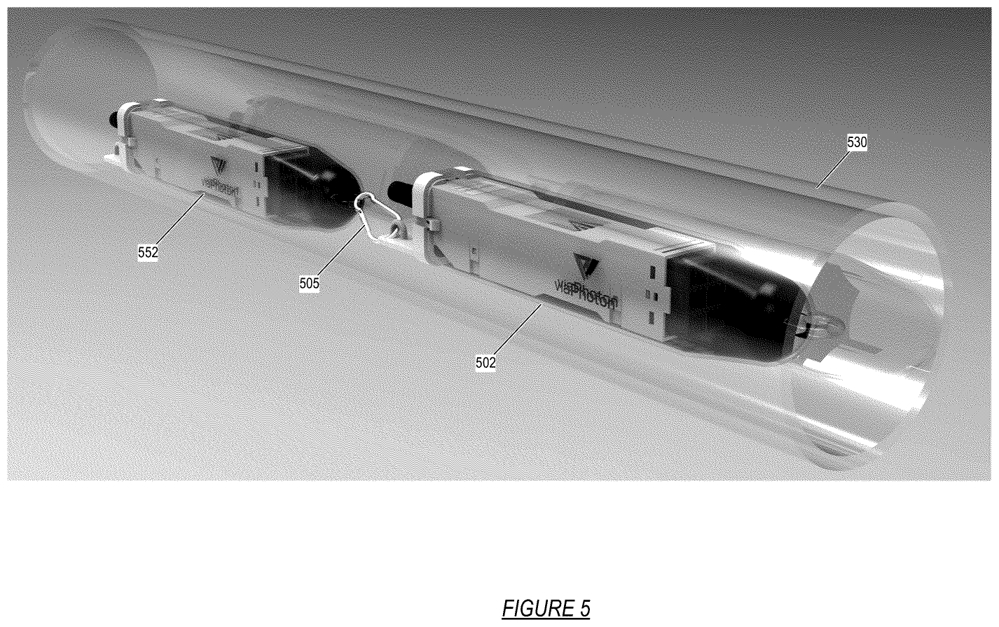

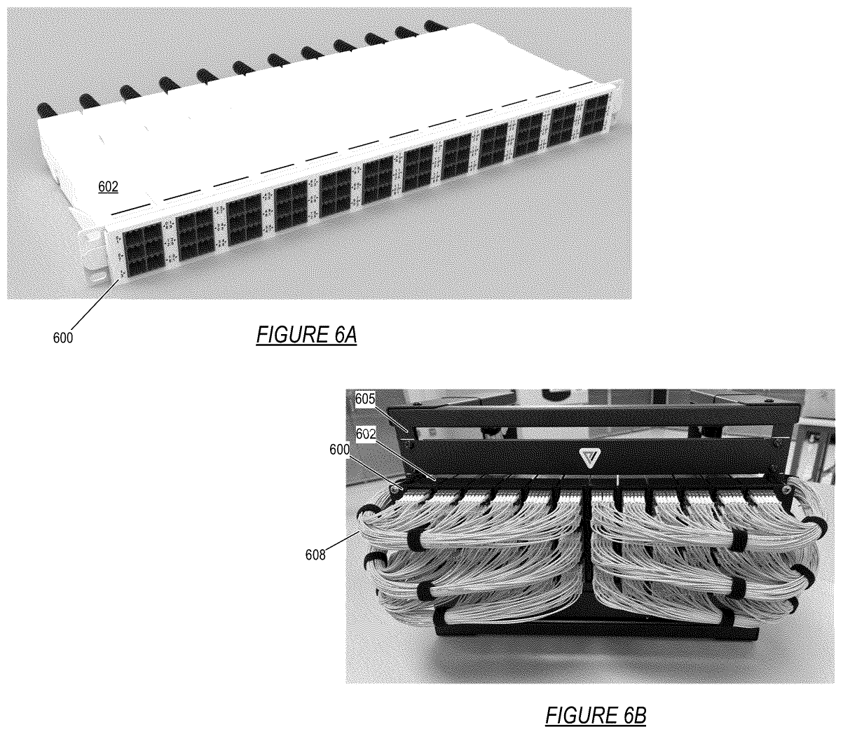

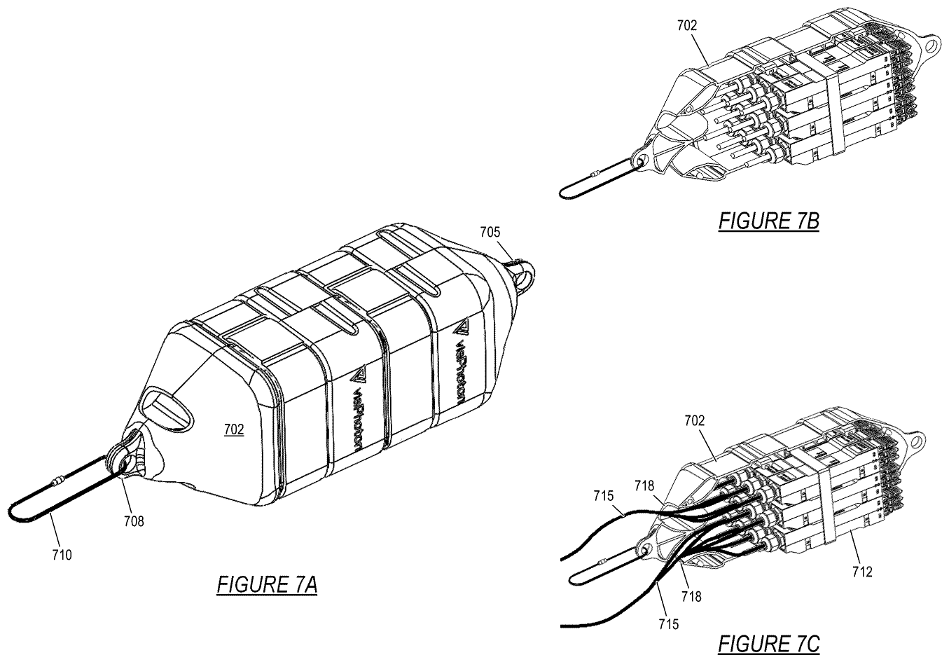

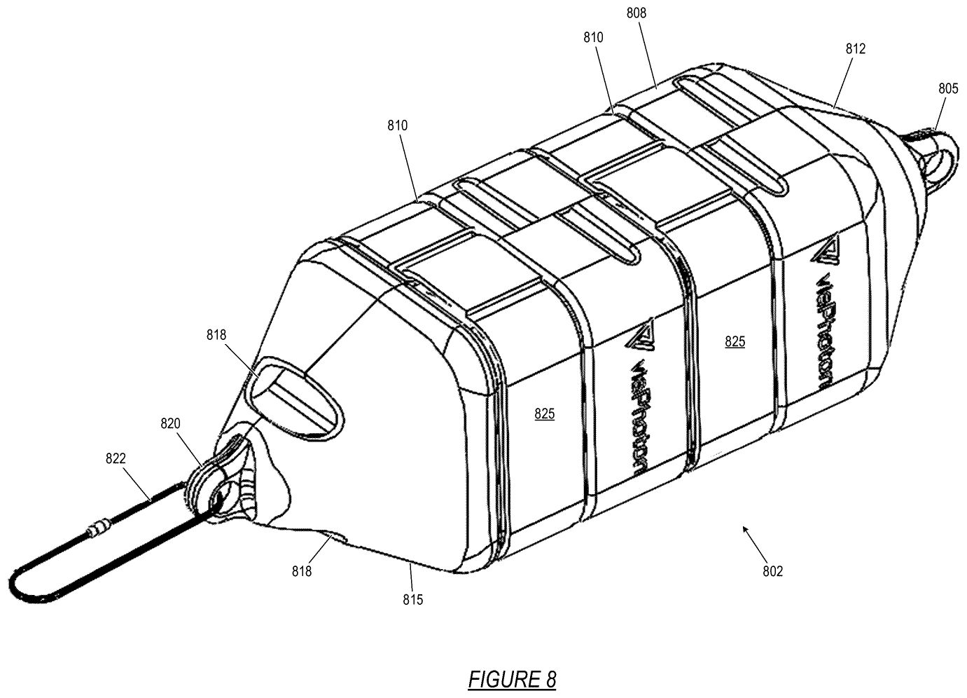

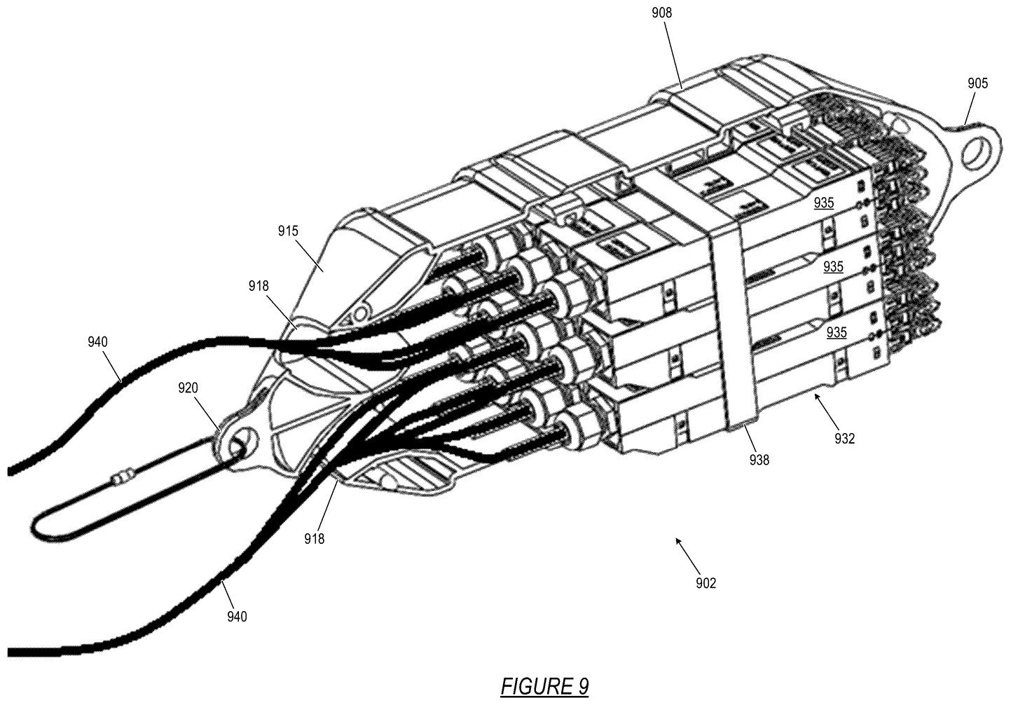

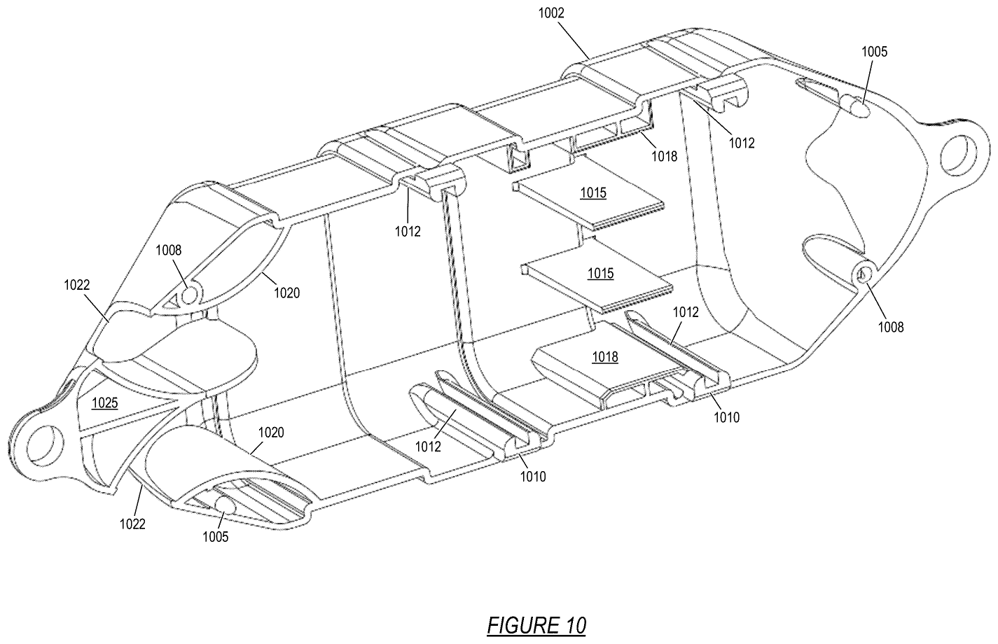

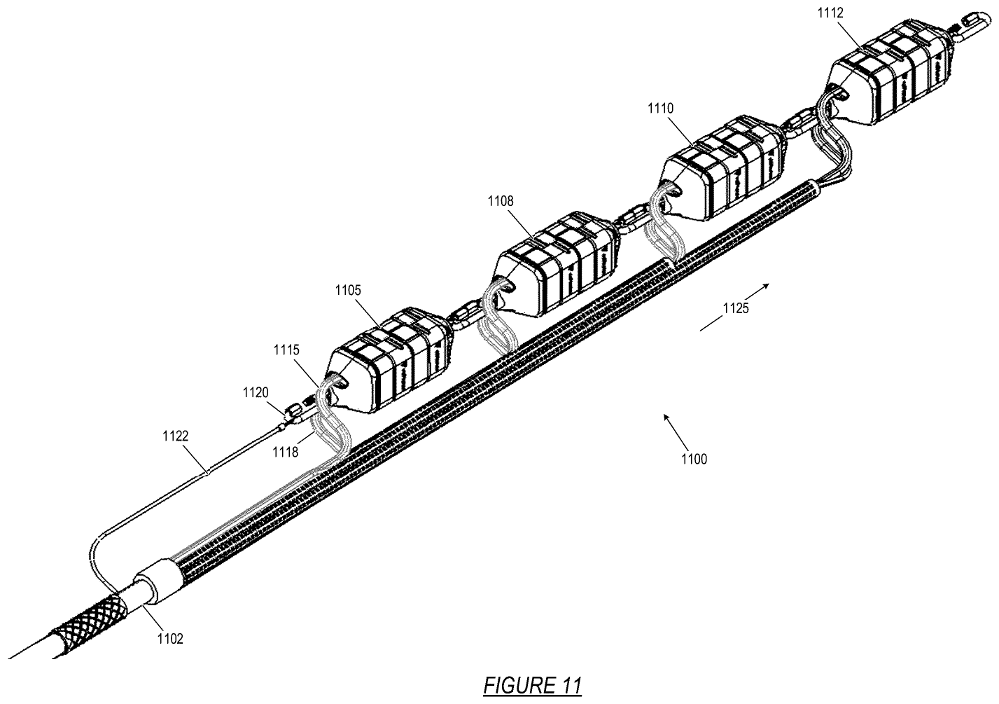

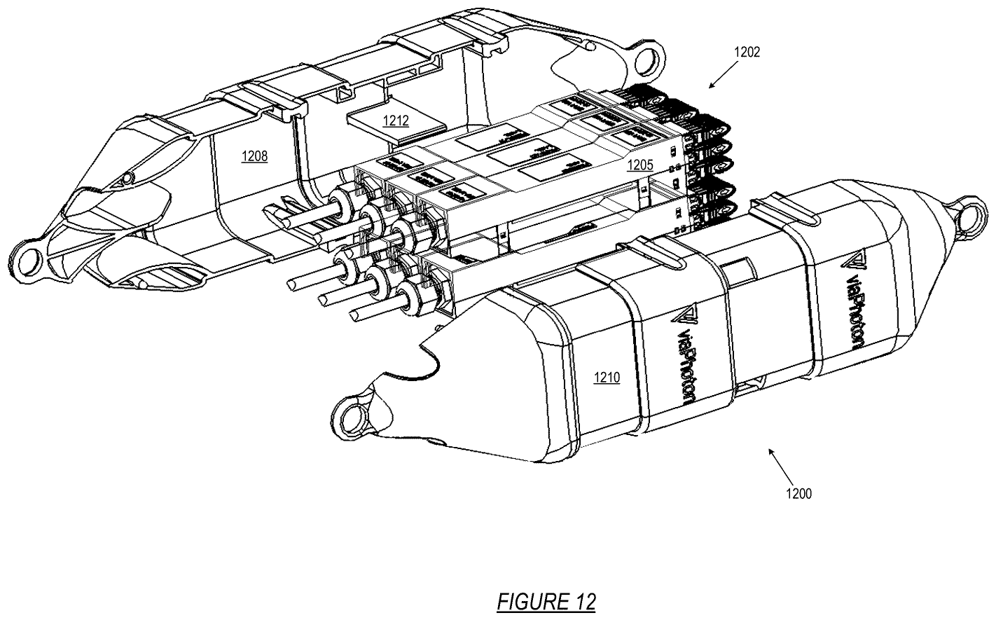

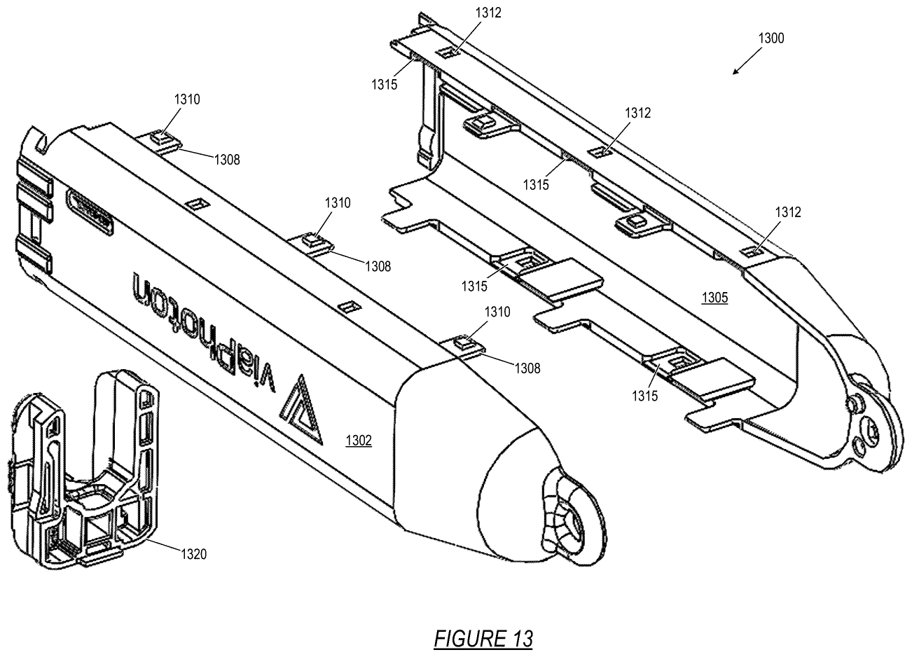

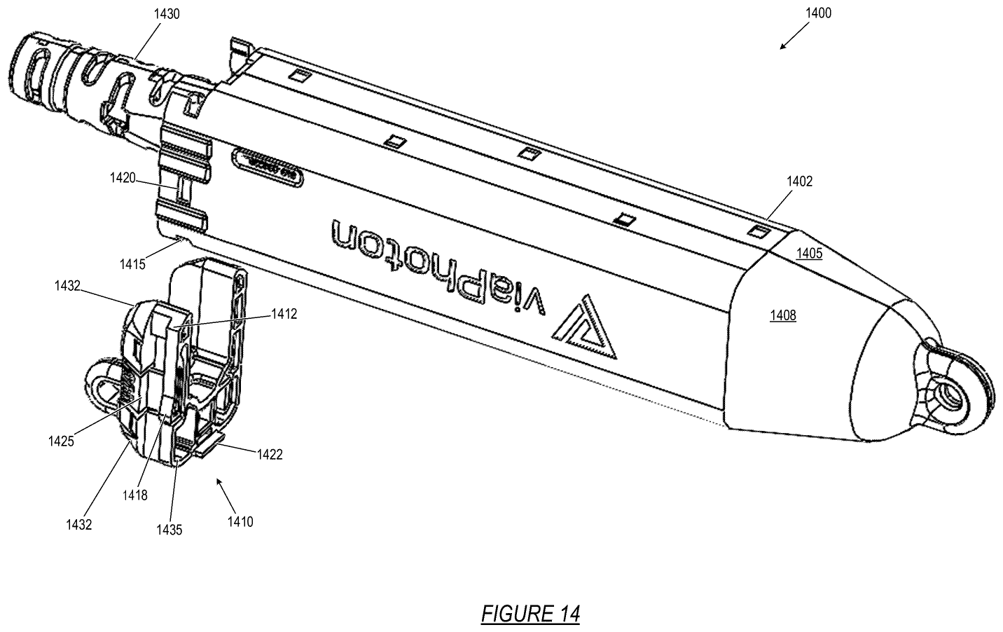

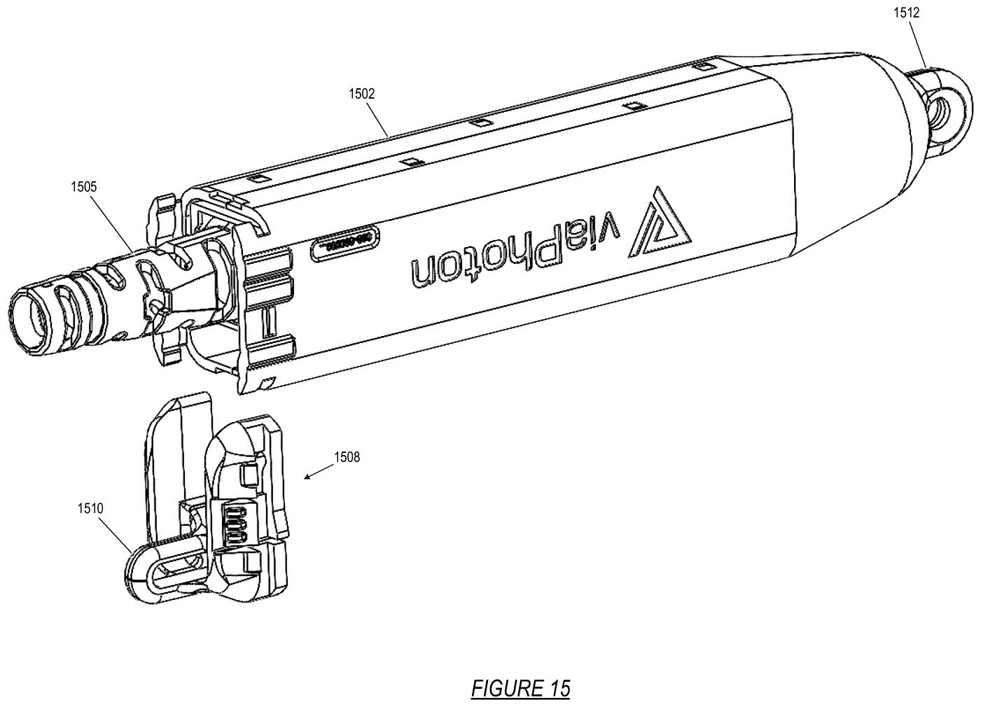

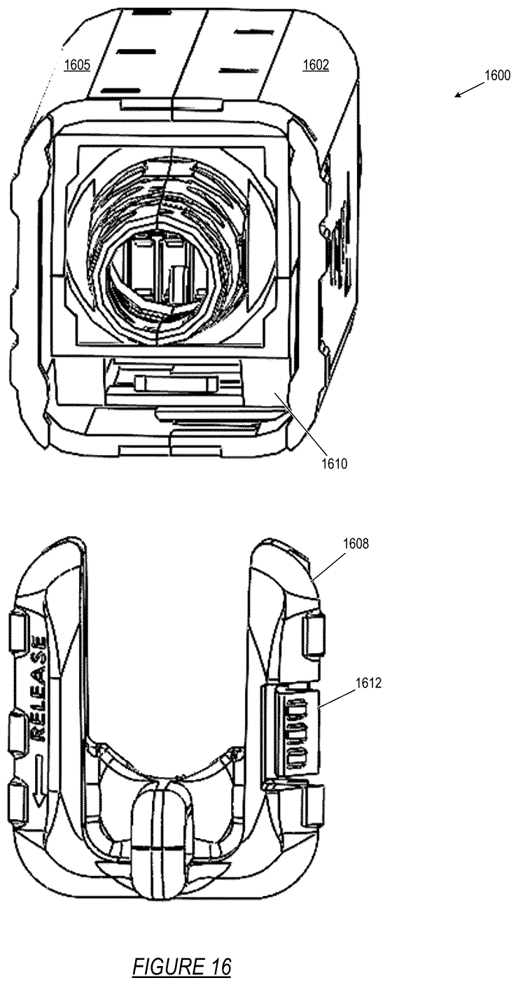

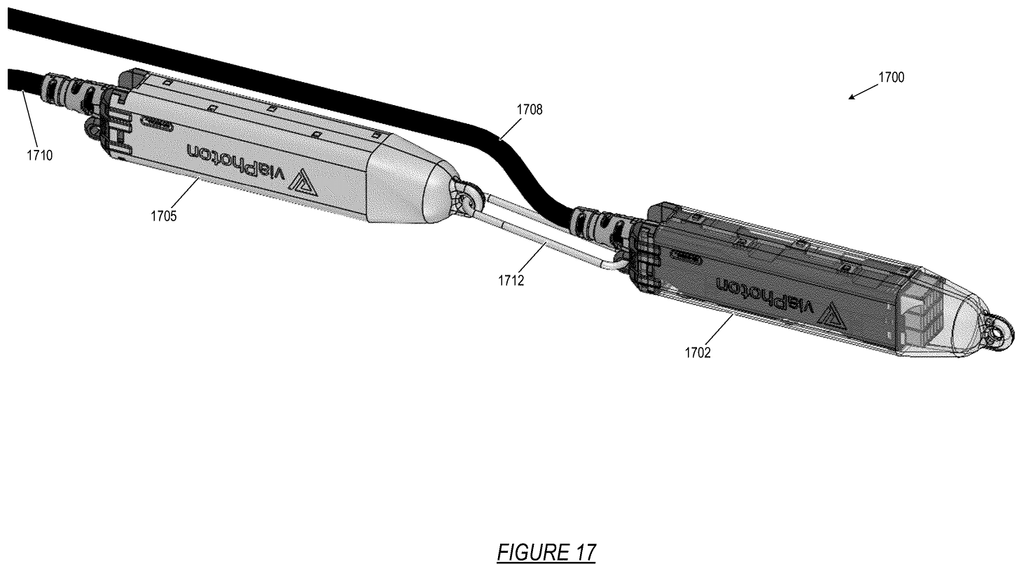

Turning to FIG. 3, the pulling container (300) includes the housing (302) and the backplate (352). The pulling container (300) secures a module (not shown) that may terminate a cable with optical fibers (not shown) to be pulled through openings (conduits, pass-through devices, cable trays, etc.). Use of the pulling container (300) prevents damage to the module and the cable so that the module and the cable may be installed to equipment.

The housing (302) may be formed from a suitably rigid material, including plastic, metal, wood, etc. In one embodiment, the housing (302) is formed from plastic, which may be transparent. The housing (302) includes the locking window (305), the alignment tab (308), and the front eyelet (310).

The locking window (305) is a feature of the housing (302). In one embodiment, the locking window (305) is integrally formed into the housing (302). In one embodiment, the locking window (305) is a rectangular opening configured to fit the retaining clip (355) of the backplate (352).

The alignment tab (308) is a feature of the housing (302). In one embodiment, the alignment tab (308) is integrally formed as part of the housing (302). In one embodiment, the alignment tab (308) is configured to fit to the slot (360) of the backplate (352).

The front eyelet (310) is a feature of the housing (302). In one embodiment, the front eyelet (310) includes a hole through which a clip may be used to connect the pulling container (300) to another pulling container, i.e., a leading pulling container, so that the pulling container (300) and the leading pulling container may each be pulled serially through an opening.

The backplate (352) may be formed from a suitably rigid material, including plastic, metal, wood, etc. The backplate (352) includes the retaining clip (355), the backstop (358), the slot (360), the back eyelet (362), and the hole (365).

The retaining clip (355) is a feature of the backplate (352) that secures the backplate (352) to the housing (302). The retaining clip (355) is configured to fasten to the locking window (305) of the housing (302).

The backstop (358) is a feature of the backplate (352) that prevents a module within the housing (302) from sliding out the back of the housing (302). The backstop (358) may be integrally formed as part of the backplate (352).

The slot (360) is a feature of the backplate (352). In one embodiment, the slot (360) is configured to accept the alignment tab (308) to align the backplate (352) with the housing (302) during assembly of the pulling container (300).

The back eyelet (362) is a feature of the backplate (352). In one embodiment, the back eyelet (362) includes a hole through which a clip may be used to connect the pulling container (300) to another pulling container, i.e., a lagging pulling container, so that the pulling container (300) and the lagging pulling container may each be pulled serially through an opening.

The hole (365) is a feature of the backplate (352), which may be formed with the slot (360). The hole (365) provides for the exit of a cable from a module fitted into the pulling container (300).

Turning to FIG. 4, the module pulling container (402) is serially connected to the module pulling container (452) with the connection article (405) and may be referred to as a bullet train. The module pulling containers (402) and (452) may be pulled through the corridors, conduits, pipes, etc., of a facility for installation of the modules and closed within the module pulling containers (402) and (452).

The module pulling containers (402) and (452) enclose the modules (405) and (455), which terminate the cables (408) and (458). The connectors (415) and (465) are protected by the front ends of the module pulling containers (402) and (452). The module pulling containers (402) and (452) include the front eyelets (412) and (462) and include the rear eyelets (410) and (460).

The connection article (405) may be a carabiner. The connection article (405) is threaded through the rear eyelet (410) of the module pulling container (402) and through the front eyelet (462) of the module pulling container (452).

Turning to FIG. 5, the module pulling containers (502) and (552) each enclose a module and are being pulled through the conduit (530). The module pulling containers (502) and (552) are connected with the connecting article (505), which is a carabiner.

Turning to FIG. 6A, the modules (602) are removed from respective module pulling containers (not shown) and installed into the panel (600). The modules (602) may be installed by sliding the modules (602) through a rear of the panel (600) to a front of the panel (600).

Turning to FIG. 6B, the panel (600) with the modules (602) is installed into the rack (605). The cables (608) are terminated with connectors that are installed into the adapters at the front ends of the modules (602).

Turning to FIG. 7A, the module pulling container (702) (also referred to as a network module torpedo or torpedo) is structured to transport multiple network modules from one location to another. The module pulling container (702) includes the front eyelet (705) and the rear eyelet (708). The module pulling container (702) may be connected in succession to additional module pulling containers (not shown) using connecting articles such as a carabiner, the cable loop (710), or similar components.

Turning to FIG. 7B, a partially assembled view of the module pulling container (702) is illustrated. The module pulling container (702) is fitted with twelve (12) modules (712) bundled inside. In an embodiment, the twelve modules may fill a row of a panel for a rack.

Turning to FIG. 7C, a partially assembled view of the module pulling container (702) is illustrated. The cables (715) terminated by the modules (712) are routed through the cable exit holes (718) of the module pulling container (702).

Turning to FIG. 8, the module pulling container (802) is illustrated. The module pulling container (802) includes the front eyelet (805), the housing (808), the grooves (810), the tapered front end (812), the tapered rear end (815), the cable exit holes (818), the rear eyelet (820), and the connecting article (822).

The front eyelet (805) may also be referred to as a front pulling eye. The front eyelet (805) allows the module pulling container (802) to be pulled from one location to another by attaching a rope (or similar pulling method) to the housing (808). The front eyelet (805) may also be used to connect additional containers to each other in succession by attaching the connecting article (822) (e.g., a carabiner or similar attachment mechanism) to a rear eyelet of a container in front of the module pulling container (802). Multiple containers may be connected together and pulled in succession.

The housing (808) forms an outer shell and may be composed of two halves that come together to form an enclosure to contain and protect multiple modules. In an embodiment, the two halves of the housing (808) may be structurally the same and made with the same tooling.

The tapered front end (812) and the tapered rear end (815) are angled surfaces of the housing (808). The tapered front end (812) and the tapered rear end (815) reduce the chance of the module pulling container (802) getting snagged on obstructions as the module pulling container (802) moves through cable pathways and around obstacles.

The cable exit holes (818) allow cables to exit the module pulling container (808). The cable exit holes (818) are positioned on two sides of the rear eyelet (820), which may be opposite sides, e.g., an upper side and a lower side.

The grooves (810) (also referred to as recessed strap area grooves) are locations on the housing (808) where the surface of the housing (808) is offset below the widest areas of the housing (808). The recess provides for fitment of the straps (825) (e.g., a hook-and-loop strap or similar strapping device) to be installed in the grooves (810). The groves (810) keep the straps (825) contained in the area of the grooves (810) so that the straps (825) do not fall off or get caught or snagged on obstructions during pulling.

Turning to FIG. 9, the module pulling container (902) is partially assembled. The module pulling container (902) includes the front eyelet (905), the housing (908), the tapered rear end (915), the rear eyelet (920), and the cable exit holes (918), the bundle (932) of modules (935), and the bundle strap (938).

The housing (908) includes two halves of the shell that come together to form an enclosure to contain and protect multiple modules. The halves of the housing (908) include fastening and aligning elements to align and fasten the halves of the housing (908) together.

The housing (908) retains and protects the bundle (932) of the twelve (12) modules (935). The cables (940) route out of the housing (908) through the cable exit holes (918) in the rear end of the module pulling container (902).

The bundle (932) of the modules (935) may be retained together using the bundle strap (938). Embodiments of the bundle strap (938) may include a hook-and-loop strap, cable ties, tape, etc. Using the bundle strap (938) keeps the modules (935) together and organized during assembly of the portions of the housing (908).

Turning to FIG. 10, the outer shell portion (1002) forms a half of a housing of a module pulling container. The outer shell portion (1002) comes together with another outer shell portion to form an enclosure to contain and protect multiple modules. The outer shell portion (1002) includes several components, features, and elements.

The alignment guide pins (1005) are inserted into the alignment guide holes (1008) to align the assembly of the outer shell portion (1002) with another outer shell portion (not shown) that may be a copy of the outer shell portion (1002). The alignment guide pins (1005) and the alignment guide holes (1008) keep the surfaces of the outer shell portion (1002) lined up with each other, even if forces are exerted on the surfaces of the outer shell. The front end of the outer shell portion (1002) includes one of the alignment guide pins (1005) and includes one of the alignment guide holes (1008). The rear end of the outer shell portion (1002) includes one of the alignment guide pins (1005) and includes one of the alignment guide holes (1008).

The shell alignment tabs (1010) keep the surfaces of the outer shell portion (1002) aligned with another outer shell portion, even if forces are exerted on the surfaces. The shell alignment tabs (1010) are formed with the module support walls (1012). The shell alignment tabs (1010) extend out from the outer shell portion (1002) to secure into another outer shell portion (not shown).

Retention members of the outer shell (1002) include the module support walls (1012), module retention fins (1015), and module retention walls (1018), which support and align a bundle of modules in the outer shell portion (1002). The retention members also prevent the modules in the bundle from sliding back towards the rear end of the module pulling container formed by the outer shell portion (1002) during pulling.

The cable guides (1020) provide cable bend radius protection. Use of the cable guides (1020) prevents cables from bending too much when exiting the module pulling container formed with the outer shell portion (1002) through the cable exit holes (1022) to reduce the risk of damaging the cables.

The strength members, including the strength rib (1025), are used to strengthen the components. Inclusion of the strength members reduces the risk of flexing or warping of the module pulling container formed from the outer shell portion (1002).

Turning to FIG. 11, the assembly (1100) includes the trunk cable (1102) includes several cables within that are terminated by modules in the containers (1105), (1108), (1110), and (1112). The cables (1115) route from modules in the container (1105) through an upper exit hole to the trunk cable (1102). The cables (1118) route through a lower exit hole of the container (1105) to the trunk cable (1102).

The connecting article (1120) is a carabiner connected to a rear eyelet of the container (1105). The connecting article (1120) connects between the container (1105) and the tension member (1122). The tension member (1122) may be a rope that connects to the trunk cable to transfer tension to the insulation of the trunk cable (1102). The assembly (1100) may be pulled in the direction (1125) to install the cables and modules in a facility.

In an embodiment, each of the containers (1105), (1108), (1110), and (1112) may be loaded with twelve modules. The twelve modules for one of the containers (1105), (1108), (1110), and (1112) may fill a panel. The panels, filled by the modules of the four containers (1105), (1108), (1110), and (1112), may fill three slots of a rack in a server cabinet.

Turning to FIG. 12, the container (1200) is illustrated in an exploded view. When assembled, the container (1200) encloses the bundle (1202) of six (6) modules (1205) between the outer shell portions (1208) and (1210). The outer shell portions (1208) and (1210) are identical to each other.

The bundle (1202) of the modules (1205) is arranged in two rows with three of the modules (1205) per each row. The outer shell portion (1208) includes the retention fin (1212) that slides between the two rows of the modules (1205) to secure the modules (1205) when the container (1200) is assembled.

Turning to FIG. 13, an exploded view of the module pulling container (1300) is illustrated. The housing of the module pulling container (1300) includes the outer shell portions (1302) and (1305) are copies of each other that may be snapped together by being pressed together. The tabs (1308) include the protrusions (1310). The tabs (1308) slide into the recessions (1315) and the protrusions (1310) snap into the corresponding holes (1312) on the opposing outer shell portion.

The tabs (1308) and corresponding recessions (1315) act as guide walls to allow the two outer shell portions (1302) and (1305) to be properly aligned and supported during the assembly process. The clip (1320) is a backplate that may be slid into place after the two outer shell portions (1302) and (1305) are assembled together. The material of the housing of the module pulling container (1300) may be made from a transparent material so the module within may be seen inside through the housing.

Turning to FIG. 14, the module pulling container (1400) includes the housing (1402) (also referred to as a bullet train module housing) that is formed from the outer shell portions (1405) and (1408) connected together with a module inside. The rear clip (1410) has not yet been slid into place.

When the rear clip (1410) is slid into place, the ridge (1412) travels along the channel (1415) in the outer shell portion (1408). The rear clip (1410) locks into place by the ramped, flexible, locking tab (1418) that becomes snapped into the corresponding void (1420) in the outer shell portion (1408) of the module housing (1402). The wall (1422) stops the rear clip (1410) from sliding in too far.

The rear clip (1410) may be made from a flexible material and be released by flexing the locking tab (1418) by squeezing or pressing the large button (1425). Pressing the button (1425) moves the flexible tab (1418) out of the void (1420) and allow the rear clip (1410) to slide out of the housing channel (1415) of the outer shell portion (1408) and a similar channel of the outer shell portion (1405).

The rear clip (1410) is “u-shaped” so that the rear clip (1410) may be installed around the cable strain relief (1430) protruding out the back of the module enclosed by the housing (1402). The rear clip (1410) includes the tapering (1432) to help the completed assembly slide backwards in the cable pathways to reduce the likelihood that the module pulling container (1400) will get caught on obstacles. The voids (1435) in the rear clip (1410) are used to keeping a uniform wall thickness in the plastic component to reduce “sink” areas of the plastic used to form the rear clip (1410).

Turning to FIG. 15, the housing (1502) encloses the module from which the strain relief (1505) protrudes. The rear clip (1508) includes the rear eyelet (1510). The housing (1502) includes the front eyelet (1512). The holes of the eyelets (1510) and (1512) face the same direction so that a connecting article may be used to connect one of the eyelets to the eyelet of another module pulling container without twisting.

Turning to FIG. 16, a rear view of the module pulling container (1600) is illustrated. The module pulling container (1600) includes the outer shell portions (1602) and (1605) and the rear clip (1608). The outer shell portions (1602) and (1605) enclose the module (1610).

The rear clamp (1608) includes the button (1612). Depressing the button (1612) allows the rear clamp (1608) to be released from the housing of the module pulling container (1600).

Turning to FIG. 17, the assembly (1700) includes two “bullet train” module pulling containers (1702) and (1705) (with modules inside) connected in succession, with the cables (1708) and (1710) coming out the back of the modules. The module pulling containers (1702) and (1705) are connected by the connecting article (1712), which may be a carabiner, a wire loop, etc.

The term “about,” when used with respect to a physical property that may be measured, refers to an engineering tolerance expected by or determined by one ordinary skill in the art. The exact quantified degree of an engineering tolerance depends on the product being produced, the process being performed, or the technical property being measured. For a non-limiting example, two angles may be “about congruent” if the values of the two angles are within ten percent of each other. However, if the ordinary artisan determines that the engineering tolerance for a particular product should be tighter, then “about congruent” could be two angles having values that are within one percent of each other. Likewise, engineering tolerances could be loosened in other embodiments, such that “about congruent” angles have values within twenty percent of each other. In any case, the ordinary artisan is capable of assessing what is an acceptable engineering tolerance for a particular product, and thus is capable of assessing how to determine the variance of measurement contemplated by the term “about.”

As used herein, the term “connected to” contemplates at least two meanings. In a first meaning, unless otherwise stated, “connected to” means that component A could have been separate from component B, but is joined to component B in either a fixed or a removably attached arrangement. In a second meaning, unless otherwise stated, “connected to” means that component A is integrally formed with component B. Thus, for example, assume a bottom of a pan is “connected to” a wall of the pan. The term “connected to” may be interpreted as the bottom and the wall being separate components that are snapped together, welded, or are otherwise fixedly or removably attached to each other. Additionally, the term “connected to” also may be interpreted as the bottom and the wall being contiguously together as a monocoque body formed by, for example, a molding process.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such, includes the term “and.” Further, items joined by the term “or” may include any combination of the items with any number of each item, unless expressly stated otherwise.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. An apparatus forming a module pulling container comprising:
a housing structured to enclose at least one module terminating a cable;
a front eyelet of the housing;
a tapered front end of the housing;
a back eyelet; and
one or more retention members structured to support the at least one module within the module pulling container.

2. The apparatus of claim 1, further comprising:
the one or more retention members comprising a backplate comprising the back eyelet.

3. The apparatus of claim 1, further comprising:
an alignment tab of the housing; and
a slot of a backplate structured to receive the alignment tab.

4. The apparatus of claim 1, further comprising:
a locking window formed as part of the housing;
a retaining clip formed as part of a backplate and structured to fit to the locking window.

5. The apparatus of claim 1, further comprising:
one or more rounded edges of the housing.

6. The apparatus of claim 1, further comprising:
an internal cross sectional area of the housing that is no more than ten percent greater than an external cross sectional area of the at least one module.

7. The apparatus of claim 1, further comprising:
a cable guide structured to provide cable bend radius protection.

8. The apparatus of claim 1, further comprising:
the at least one module.

9. The apparatus of claim 1, further comprising:
the one or more retention members comprising a retention wall and a retention fin.

10. The apparatus of claim 1, further comprising:
an alignment guide pin of the housing;
an alignment guide hole of the housing structured to receive the alignment guide pin.

11. A system comprising:
a cable;
a module pulling container comprising:
a housing structured to enclose at least one module terminating the cable; a front eyelet of the housing;
a tapered front end of the housing;
a back eyelet; and
one or more retention members structured to support the at least one module within the module pulling container.

12. The system of claim 11, further comprising:
the one or more retention members comprising a backplate comprising the back eyelet.

13. The system of claim 11, further comprising:
an alignment tab of the housing; and
a slot of a backplate structured to receive the alignment tab.

14. The system of claim 11, further comprising:
a locking window formed as part of the housing;
a retaining clip formed as part of a backplate and structured to fit to the locking window.

15. The system of claim 11, further comprising:
one or more rounded edges of the housing.

16. The system of claim 11, further comprising:
an internal cross sectional area of the housing that is no more than ten percent greater than an external cross sectional area of the at least one module.

17. The system of claim 11, further comprising:
a cable guide structured to provide cable bend radius protection.

18. The system of claim 11, further comprising:
the at least one module.

19. The system of claim 11, further comprising:
the one or more retention members comprising a retention wall and a retention fin.

20. A method comprising:
terminating a cable with a module;
enclosing the module within a module pulling container comprising:
a housing structured to enclose at least one module terminating a cable;
a front eyelet of the housing;
a tapered front end of the housing;
a back eyelet; and
one or more retention members structured to support the at least one module within the module pulling container.
